(19) United States
(12) Patent Application Publication
(10) Pub. No.: US 2004/0201844 A1
(43) Pub. Date: Oct. 14, 2004

(54) System, method and product for providing a stable calibration standard for optical systems

(75) Inventor: Gregory C. Loney, Concord, MA (US)

Correspondence Address: AFFYMETRIX, INC, ATTN: CHIEF IP COUNSEL, LEGAL DEPT., 3380 CENTRAL EXPRESSWAY, SANTA CLARA, CA, 95051, US

(73) Assignee: Affymetrix, INC., a Corporation Organized under the Laws of Delaware, Santa Clara, CA

(21) Appl. No.: 10/770,717

(22) Filed: Feb. 3, 2004

Related U.S. Application Data
(60) Provisional application No. 60/444,567, filed on Feb. 3, 2003.

(51) Int. Cl. G01N 21/64

(52) U.S. Cl. 356/318; 250/458.1

(57) ABSTRACT

A system is described for providing a wavelength of light that comprises: a scanner that provides a first wavelength; and an optical assembly that emits a second wavelength based, at least in part upon the first wavelength, wherein the second wavelength is not the result of a fluorescent emission.

### RELATED APPLICATIONS

The present application claims priority to U.S. Provisional Patent Application Serial No. 60/444,567, titled “System, Method and Product for Gain Calibration in Optical Scanning Systems”, filed Feb. 3, 2003, which is hereby incorporated by reference herein in its entirety for all purposes.

### FIELD OF THE INVENTION

The present invention relates to scanning systems and products employed for producing reliable and comparable biological probe array data from multiple instruments. In particular, the present invention relates to systems, methods, and products calibrating one or more components of a scanner instrument using a calibration standard in order to provide matched performance between scanner instruments.

### BACKGROUND

Synthesized nucleic acid probe arrays, such as Affymetrix GeneChip® probe arrays, and spotted probe arrays, have been used to generate unprecedented amounts of information about biological systems. For example, the GeneChip® Human Genome U133 Plus 2.0 array available from Affymetrix, Inc. of Santa Clara, Calif., is comprised of a single microarray containing over 1,000,000 unique oligonucleotide features covering more than 47,000 transcripts that represent more than 33,000 human genes. Analysis of expression data from such microarrays may lead to the development of new drugs and new diagnostic tools.

### SUMMARY OF THE INVENTION

The expanding use of microarray technology is one of the forces driving the development of bioinformatics. In particular, microarrays and associated instrumentation and computer systems have been developed for rapid and large-scale collection of data about the expression of genes or expressed sequence tags (EST's) in tissue samples. Microarray technology and associated instrumentation and computer systems employ a variety of methods to obtain the accurate data from microarray experiments. Scanning of arrays is an essential step in microarray experiments and relies, amongst numerous other factors, on accurate calibration of the scanning system; this being of vital importance to obtain reliable data. Researchers are in need of increasingly accurate data generated by microarray technologies. There exists a strong need for optical scanning systems to exhibit matched performance when detecting fluorophore emission intensity at constant fluorophore concentration and constant excitation properties (e.g. excitation light wavelength, excitation light power). The difficulty with establishing this match is that no stable calibration sources exist to adjust the systems.

Systems, methods, and products are described herein to address these and other needs. Various alternatives, modifications and equivalents are possible.

A system is described for providing a wavelength of light that comprises: a scanner that provides a first wavelength; and an optical assembly that emits a second wavelength based, at least in part upon the first wavelength, wherein the second wavelength is not the result of a fluorescent emission.

In some embodiments the first wavelength corresponds to a wavelength that excites one or more fluorescent molecules, and the fluorescent emission corresponds to an emission from a fluorescent molecule associated with a target molecule present in a biological sample.

In the same or alternative embodiments the optical assembly further comprises: a detector that detects a first measure of power associated with the first wavelength; a control unit that provides a second measure of power proportional to the first measure of power, where the second measure of power is associated with the second wavelength; and a source that emits the second wavelength at the second measure of power. Further in some implementations, the system includes an instrument control application that calibrates one or more detectors associated with the scanner that, for instance may include gain calibration.

A method for providing a wavelength of light is described that comprises: providing a first wavelength; and emitting a second wavelength based, at least in part upon the first wavelength, where the second wavelength is not the result of a fluorescent emission.

In some embodiments, the first wavelength corresponds to a wavelength capable of exciting one or more fluorescent molecules, and the fluorescent emission corresponds to an emission from a fluorescent molecule associated with a target molecule that is present in a biological sample.

In the same or alternative embodiments, the step of emitting further comprises: detecting a first measure of power associated with the first wavelength; providing a second measure of power proportional to the first measure of power, where the second measure of power is associated with the second wavelength; and emitting the second wavelength at the second measure of power. Further, some implementations may include the step of calibrating one or more detectors associated with the scanner based, at least in part, upon the second wavelength and the second measure of power.

An optical assembly is described that comprises: a detector that detects a first measure of power associated with a first wavelength; a control unit that provides a second measure of power proportional to the first measure of power, where the second measure of power is associated with a second wavelength; and a source that emits the second wavelength at the second measure of power.

Also a method of using an optical assembly is described that comprises: detecting a first measure of power associated with a first wavelength; providing a second measure of power proportional to the first measure of power, where the second measure of power is associated with a second wavelength; and emitting the second wavelength at the second measure of power.

Additionally, a system for calibrating a scanner is described that comprises: a scanner that provides a first wavelength; a first detector that detects a first measure of power associated with the first wavelength; a control unit that provides a second measure of power proportional to the first measure of power, where the second measure of power is associated with a second wavelength; a source that emits the second wavelength at the second measure of power; a second detector associated with the scanner, wherein the second detector generates a signal based, at least in part, upon the second wavelength and the second measure of power; and an instrument control application that calibrates the second detector based, at least in part, upon the signal.

A method for calibrating a scanner is described that comprises: providing a first wavelength; detecting a first measure of power associated with the first wavelength; providing a second measure of power proportional to the first measure of power, where the second measure of power is associated with a second wavelength; emitting the second wavelength at the second measure of power; generating a signal based, at least in part, upon the second wavelength and the second measure of power; and calibrating the second detector based, at least in part, upon the signal.

Another system for calibrating a scanner is described that comprises: a scanner that provides a first wavelength; an optical assembly that comprises: a first detector that detects a first measure of power associated with the first wavelength; a control unit that provides a second measure of power proportional to the first measure of power, wherein the second measure of power is associated with a second wavelength; and a source that emits the second wavelength at the second measure of power; a second detector associated with the scanner, where the second detector generates a signal based, at least in part, upon the second wavelength and the second measure of power; and a computer having system memory with an instrument control application stored thereon, wherein the instrument control application executes the step of: calibrating the second detector based, at least in part, upon the signal.

The above implementations are not necessarily inclusive or exclusive of each other and may be combined in any manner that is non-conflicting and otherwise possible, whether they be presented in association with a same, or a different, aspect or implementation. The description of one implementation is not intended to be limiting with respect to other implementations. Also, any one or more function, step, operation, or technique described elsewhere in this specification may, in alternative implementations, be combined with any one or more function, step, operation, or technique described in the summary. Thus, the above implementations are illustrative rather than limiting.

### BRIEF DESCRIPTION OF THE DRAWINGS

The above and further advantages will be more clearly appreciated from the following detailed description when taken in conjunction with the accompanying drawings. In the drawings, like reference numerals indicate like structures or method steps and the leftmost one or two digits of a reference numeral indicate the number of the figure in which the referenced element first appears (for example, the element 100 appears first in FIG. 1). In functional block diagrams, rectangles generally indicate functional elements, parallelograms generally indicate data, rectangles with curved sides generally indicate stored data, rectangles with a pair of double borders generally indicate predefined functional elements, and keystone shapes generally indicate manual operations. In method flow charts, rectangles generally indicate method steps and diamond shapes generally indicate decision elements. All of these conventions, however, are intended to be typical or illustrative, rather than limiting.

FIG. 1 is a functional block diagram of one embodiment of an optical assembly, scanner system, and computer having an instrument control and image processing application;

FIG. 2A is a simplified graphical representation of one embodiment of the optical assembly of FIG. 1 associated with optics and detectors associated with the scanner; and

FIG. 2B is a simplified graphical representation of one embodiment of the optical assembly of FIG. 1 with detector, control unit and source; and

FIG. 3 is a functional block diagram of one embodiment of a method of calibrating a scanner using the optical assembly of FIG. 1.

### DETAILED DESCRIPTION

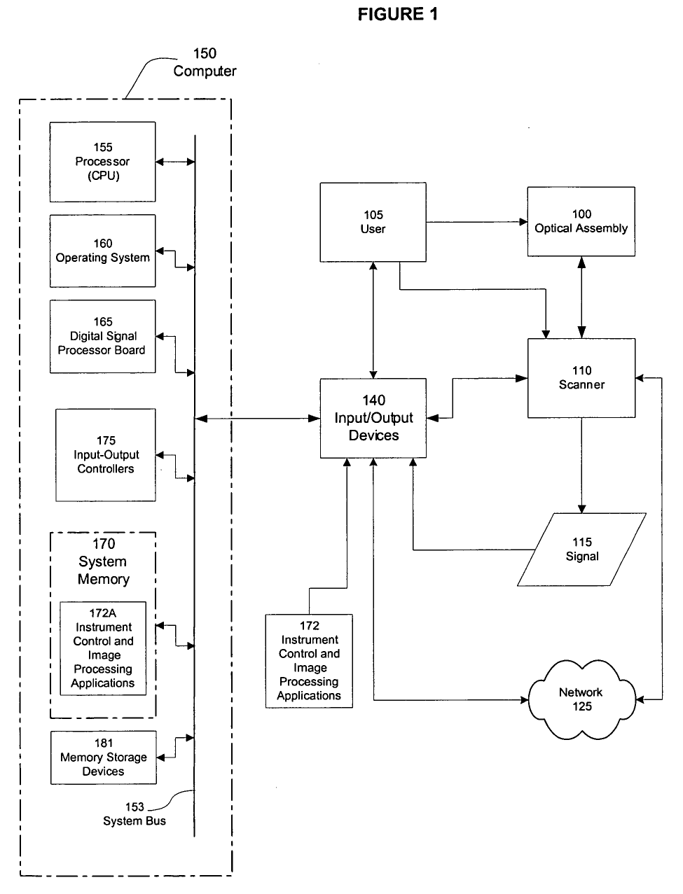

The present invention may be embodied as a system for providing a stable calibration standard for an optical scanner system, a method, of calibrating, computer software program product or products, or any combination thereof. Illustrative embodiments are now described with reference to the optical assembly and computer system as illustrated in FIG. 1. The operations of this computer system and of instrument control and image processing applications executables l72A such as, for instance, the GeneChip® Operating Software (GCOS) available from Affymetrix®, Inc. of Santa Clara Calif., executed on computers of this system, are illustrated in the context of calibrating an optical scanning system using a stable calibration standard such as optical assembly 100, that enables high quality and repeatable data generation, and processing from hybridized probe arrays. This data generating includes the scanning of hybridized probe arrays by scanner 110 and the processing of the resulting information (and other data) by software executing on representative computer 150 such as instrument control and image processing applications executables l72A. Further, data handling and other aspects of management is carried out by the image processing applications executables 172A enabled to utilize local and remote resources such as available on a server.

a) General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, New York, Gait, “Oligonucleotide Synthesis: A Practical Approach” 1984, IRL Press, London, Nelson and Cox (2000), Lehninger, Principles of Biochemistry 3rd Ed., W. H. Freeman Pub., New York, N.Y. and Berg et al. (2002) Biochemistry, 5th Ed., W. H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication Number WO 99/36760) and PCT/US01/04285 (International Publication Number WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip®. Example arrays are shown on the website at affymetrix.com.

The present invention also contemplates many uses for polymers attached to solid substrates. These uses include gene expression monitoring, profiling, library screening, genotyping and diagnostics. Gene expression monitoring, and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 60/319,253, 10/013,598 (U.S. Patent Application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, e.g., PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188, and 5,333,675, and each of which is incorporated herein by reference in their entireties for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (e.g., Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. No. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. Ser. Nos. 09/916,135, 09/920,491 (U.S. Patent Application Publication 20030096235), Ser. No. 09/910,292 (U.S. Patent Application Publication 20030082543), and Ser No. 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2nd Ed. Cold Spring Harbor, N.Y, 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Ser. No. 60/364,731 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 60/493,495 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, e.g. Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2nd ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (United States Publication No. US20020183936), Ser. Nos. 10/065,856, 10/065,868, 10/328,818, 10/328,872, 10/423,403, and 60/482,389.

b) Definitions

An “array” is an intentionally created collection of molecules which can be prepared either synthetically or biosynthetically. The molecules in the array can be identical or different from each other. The array can assume a variety of formats, e.g., libraries of soluble molecules; libraries of compounds tethered to resin beads, silica chips, or other solid supports.

Nucleic acid library or array is an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Biopolymer or biological polymer: is intended to mean repeating units of biological or chemical moieties. Representative biopolymers include, but are not limited to, nucleic acids, oligonucleotides, amino acids, proteins, peptides, hormones, oligosaccharides, lipids, glycolipids, lipopolysaccharides, phospholipids, synthetic analogues of the foregoing, including, but not limited to, inverted nucleotides, peptide nucleic acids, Meta-DNA, and combinations of the above. “Biopolymer synthesis” is intended to encompass the synthetic production, both organic and inorganic, of a biopolymer.

Related to a bioploymer is a “biomonomer” which is intended to mean a single unit of biopolymer, or a single unit which is not part of a biopolymer. Thus, for example, a nucleotide is a biomonomer within an oligonucleotide biopolymer, and an amino acid is a biomonomer within a protein or peptide biopolymer; avidin, biotin, antibodies, antibody fragments, etc., for example, are also biomonomers. Initiation Biomonomer: or “initiator biomonomer” is meant to indicate the first biomonomer which is covalently attached via reactive nucleophiles to the surface of the polymer, or the first biomonomer which is attached to a linker or spacer arm attached to the polymer, the linker or spacer arm being attached to the polymer via reactive nucleophiles.

Complementary or substantially complementary: Refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, substantial complementary exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

Combinatorial Synthesis Strategy: A combinatorial synthesis strategy is an ordered strategy for parallel synthesis of diverse polymer sequences by sequential addition of reagents which may be represented by a reactant matrix and a switch matrix, the product of which is a product matrix. A reactant matrix is a 1 column by m row matrix of the building blocks to be added. The switch matrix is all or a subset of the binary numbers, preferably ordered, between 1 and m arranged in columns. A “binary strategy” is one in which at least two successive steps illuminate a portion, often half, of a region of interest on the substrate. In a binary synthesis strategy, all possible compounds which can be formed from an ordered set of reactants are formed. In most preferred embodiments, binary synthesis refers to a synthesis strategy which also factors a previous addition step. For example, a strategy in which a switch matrix for a masking strategy halves regions that were previously illuminated, illuminating about half of the previously illuminated region and protecting the remaining half (while also protecting about half of previously protected regions and illuminating about half of previously protected regions). It will be recognized that binary rounds may be interspersed with non-binary rounds and that only a portion of a substrate may be subjected to a binary scheme. A combinatorial “masking” strategy is a synthesis which uses light or other spatially selective deprotecting or activating agents to remove protecting groups from materials for addition of other materials such as amino acids.

Effective amount refers to an amount sufficient to induce a desired result.

Genome is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

Hybridization conditions will typically include salt concentrations of less than about 1M, more usually less than about 500 mM and preferably less than about 200 mM. Hybridization temperatures can be as low as 5.degree. C., but are typically greater than 22.degree. C., more typically greater than about 30.degree. C., and preferably in excess of about 37.degree. C. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone.

Hybridizations, e.g., allele-specific probe hybridizations, are generally performed under stringent conditions. For example, conditions where the salt concentration is no more than about 1 Molar (M) and a temperature of at least 25 degrees-Celsius (° C.), e.g., 750 mM NaCl, 50 mM NaPhosphate, 5 mM EDTA, pH 7.4 (5×SSPE) and a temperature of from about 25 to about 30° C.

Hybridizations are usually performed under stringent conditions, for example, at a salt concentration of no more than 1 M and a temperature of at least 25° C. For example, conditions of 5×SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook, Fritsche and Maniatis. “Molecular Cloning A laboratory Manual” 2nd Ed. Cold Spring Harbor Press (1989) which is hereby incorporated by reference in its entirety for all purposes above.

The term “hybridization” refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.”

Hybridization probes are oligonucleotides capable of binding in a base-specific manner to a complementary strand of nucleic acid. Such probes include peptide nucleic acids, as described in Nielsen et al., Science 254, 1497-1500 (1991), and other nucleic acid analogs and nucleic acid mimetics.

Hybridizing specifically to: refers to the binding, duplexing, or hybridizing of a molecule substantially to or only to a particular nucleotide sequence or sequences under stringent conditions when that sequence is present in a complex mixture (e.g., total cellular) DNA or RNA.

Isolated nucleic acid is an object species invention that is the predominant species present (i.e., on a molar basis it is more abundant than any other individual species in the composition). Preferably, an isolated nucleic acid comprises at least about 50, 80 or 90% (on a molar basis) of all macromolecular species present. Most preferably, the object species is purified to essential homogeneity (contaminant species cannot be detected in the composition by conventional detection methods).

Ligand: A ligand is a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (e.g., opiates, steroids, etc.), hormone receptors, peptides, enzymes, enzyme substrates, substrate analogs, transition state analogs, cofactors, drugs, proteins, and antibodies.

Linkage disequilibrium or allelic association means the preferential association of a particular allele or genetic marker with a specific allele, or genetic marker at a nearby chromosomal location more frequently than expected by chance for any particular allele frequency in the population. For example, if locus X has alleles a and b, which occur equally frequently, and linked locus Y has alleles c and d, which occur equally frequently, one would expect the combination ac to occur with a frequency of 0.25. If ac occurs more frequently, then alleles a and c are in linkage disequilibrium. Linkage disequilibrium may result from natural selection of certain combination of alleles or because an allele has been introduced into a population too recently to have reached equilibrium with linked alleles.

Mixed population or complex population: refers to any sample containing both desired and undesired nucleic acids. As a non-limiting example, a complex population of nucleic acids may be total genomic DNA, total genomic RNA or a combination thereof. Moreover, a complex population of nucleic acids may have been enriched for a given population but include other undesirable populations. For example, a complex population of nucleic acids may be a sample which has been enriched for desired messenger RNA (MRNA) sequences but still includes some undesired ribosomal RNA sequences (rRNA).

Monomer: refers to any member of the set of molecules that can be joined together to form an oligomer or polymer. The set of monomers useful in the present invention includes, but is not restricted to, for the example of (poly)peptide synthesis, the set of L-amino acids, D-amino acids, or synthetic amino acids. As used herein, “monomer” refers to any member of a basis set for synthesis of an oligomer. For example, dimers of L-amino acids form a basis set of 400 “monomers” for synthesis of polypeptides. Different basis sets of monomers may be used at successive steps in the synthesis of a polymer. The term “monomer” also refers to a chemical subunit that can be combined with a different chemical subunit to form a compound larger than either subunit alone.

mRNA or mRNA transcripts: as used herein, include, but not limited to pre-mRNA transcript(s), transcript processing intermediates, mature mRNA(s) ready for translation and transcripts of the gene or genes, or nucleic acids derived from the MRNA transcript(s). Transcript processing may include splicing, editing and degradation. As used herein, a nucleic acid derived from an MRNA transcript refers to a nucleic acid for whose synthesis the MRNA transcript or a subsequence thereof has ultimately served as a template. Thus, a cDNA reverse transcribed from an MRNA, an RNA transcribed from that cDNA, a DNA amplified from the cDNA, an RNA transcribed from the amplified DNA, etc., are all derived from the MRNA transcript and detection of such derived products is indicative of the presence and/or abundance of the original transcript in a sample. Thus, MRNA derived samples include, but are not limited to, MRNA transcripts of the gene or genes, cDNA reverse transcribed from the MRNA, cRNA transcribed from the cDNA, DNA amplified from the genes, RNA transcribed from amplified DNA, and the like.

Nucleic acid library or array is an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Nucleic acids according to the present invention may include any polymer or oligomer of pyrimidine and purine bases, preferably cytosine, thymine, and uracil, and adenine and guanine, respectively. See Albert L. Lehninger, Principles of Biochemistry, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

An “oligonucleotide” or “polynucleotide” is a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

Probe: A probe is a surface-immobilized molecule that can be recognized by a particular target. See U.S. Pat. No. 6,582,908 for an example of arrays having all possible combinations of probes with 10, 12, and more bases. Examples of probes that can be investigated by this invention include, but are not restricted to, agonists and antagonists for cell membrane receptors, toxins and venoms, viral epitopes, hormones (e.g., opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

Primer is a single-stranded oligonucleotide capable of acting as a point of initiation for template-directed DNA synthesis under suitable conditions e.g., buffer and temperature, in the presence of four different nucleoside triphosphates and an agent for polymerization, such as, for example, DNA or RNA polymerase or reverse transcriptase. The length of the primer, in any given case, depends on, for example, the intended use of the primer, and generally ranges from 15 to 30 nucleotides. Short primer molecules generally require cooler temperatures to form sufficiently stable hybrid complexes with the template. A primer need not reflect the exact sequence of the template but must be sufficiently complementary to hybridize with such template. The primer site is the area of the template to which a primer hybridizes. The primer pair is a set of primers including a 5′ upstream primer that hybridizes with the 5′ end of the sequence to be amplified and a 3′ downstream primer that hybridizes with the complement of the 3′ end of the sequence to be amplified.

Polymorphism refers to the occurrence of two or more genetically determined alternative sequences or alleles in a population. A polymorphic marker or site is the locus at which divergence occurs. Preferred markers have at least two alleles, each occurring at frequency of greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. Single nucleotide polymorphisms (SNPs) are included in polymorphisms.

Receptor: A molecule that has an affinity for a given ligand. Receptors may be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term receptors is used herein, no difference in meaning is intended. A “Ligand Receptor Pair” is formed when two macromolecules have combined through molecular recognition to form a complex. Other examples of receptors which can be investigated by this invention include but are not restricted to those molecules shown in U.S. Pat. No. 5,143,854, which is hereby incorporated by reference in its entirety.

“Solid support”, “support”, and “substrate” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

Target: A molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term targets is used herein, no difference in meaning is intended. A “Probe Target Pair” is formed when two macromolecules have combined through molecular recognition to form a complex.

c) Embodiments of the Present Invention

Scanner 110: Labeled targets hybridized to probe arrays may be detected using various devices, sometimes referred to as scanners, as described above with respect to methods and apparatus for signal detection. An illustrative device is shown in FIG. 1 as scanner 110. For example, scanners image the targets by detecting fluorescent or other emissions from labels associated with target molecules, or by detecting transmitted, reflected, or scattered radiation. A typical scheme employs optical and other elements to provide excitation light and to selectively collect the emissions.

For example, scanner 110 provides signal 115 representing the intensities (and possibly other characteristics, such as color) of the detected emissions or reflected wavelengths of light, as well as the locations on the substrate where the emissions or reflected wavelengths were detected. Typically, signal 115 includes intensity information corresponding to elemental sub-areas of the scanned substrate. The term “elemental” in this context means that the intensities, and/or other characteristics, of the emissions or reflected wavelengths from this area each are represented by a single value. When displayed as an image for viewing or processing, elemental picture elements, or pixels, often represent this information. Thus, in the present example, a pixel may have a single value representing the intensity of the elemental sub-area of the substrate from which the emissions or reflected wavelengths were scanned. The pixel may also have another value representing another characteristic, such as color, positive or negative image, or other type of image representation. Two examples where signal 115 may be incorporated into data are data files in the form *.dat or *.tif as generated respectively by Affymetrix® Microarray Suite (described in U.S. patent application Ser. No. 10/219,882, incorporated above) or Affymetrix® GeneChip® Operating Software based on images scanned from GeneChip® arrays, and Affymetrix® Jaguar™ software (described in U.S. Provisional Patent Application No. 60/226,999, incorporated above) based on images scanned from spotted arrays. Examples of scanner systems that may be implemented with embodiments of the present invention include U.S. patent application Ser. No. 10/389,194, titled “System, Method and Product for Scanning of Biological Materials”, filed Mar. 14, 2003; and U.S. Provisional Patent Application Serial No. 60/493,495, titled “System, Method, and Product for Scanning of Biological Materials Employing dual analog integrators”, filed Aug. 8, 2003, both of which are hereby incorporated by reference herein in their entireties for all purposes.

Computer 150: Signal 115 may be stored and/or processed by a computer system such as any one or more of a number of computers connected to network 125, generally and collectively referred to as computer 150. An example of computer 150 is illustrated in FIG. 1. Computer 150 may be any type of computer platform such as a workstation, a personal computer, a server, or any other present or future computer. Computer 150 typically includes known components such as a processor 155, an operating system 160, digital signal processor board 165, system memory 170, memory storage devices 181, input-output controllers 175, and input/output devices 140. In particular, output controllers of input-output controllers 175 could include controllers for any of a variety of known display devices, network cards, and other devices well known to those of ordinary skill in the relevant art. Input/Output Devices 140 may include display devices that provides visual information, this information typically may be logically and/or physically organized as an array of pixels. A Graphical user interface (GUI) controller may also be included that may comprise any of a variety of known or future software programs for providing graphical input and output interfaces to a user, such as user 105, and for processing user inputs.

It will be understood by those skilled in the relevant art that there are many possible configurations of the components of computer 150 and that some components that may typically be included in computer 150 are not shown, such as cache memory, a data backup unit, and many other devices. Processor 155 may be a commercially available processor such as a Pentium® processor made by Intel Corporation, a SPARC® processor made by Sun Microsystems, or it may be one of other processors that are or will become available. Processor 155 executes operating system 160, which may be, for example, a Windows®-type operating system (such as Windows NT® 4.0 with SP6a) from the Microsoft Corporation; a Unix® or Linux-type operating system available from many vendors; another or a future operating system; or some combination thereof. Operating system 160 interfaces with firmware and hardware in a well-known manner, and facilitates processor 155 in coordinating and executing the functions of various computer programs that may be written in a variety of programming languages. Operating system 160, typically in cooperation with processor 155, coordinates and executes functions of the other components of computer 150. Operating system 160 also provides scheduling, input-output control, file and data management, memory management, and communication control and related services, all in accordance with known techniques.

System memory 170 may be any of a variety of known or future memory storage devices. Examples include any commonly available random access memory (RAM), magnetic medium such as a resident hard disk or tape, an optical medium such as a read and write compact disc, or other memory storage device. Memory storage device 181 may be any of a variety of known or future devices, including a compact disk drive, a tape drive, a removable hard disk drive, or a diskette drive. Such types of memory storage device 181 typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory 170 and/or the program storage device used in conjunction with memory storage device 181.

In some embodiments, a computer program product is described comprising a computer usable medium having control logic (computer software program, including program code) stored therein. The control logic, when executed by processor 155, causes processor 155 to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 175 could include any of a variety of known devices for accepting and processing information from a user, whether a human or a machine, whether local or remote. Such devices include, for example, modem cards, network interface cards, sound cards, or other types of controllers for any of a variety of known input devices. Output controllers of input-output controllers 175 could include controllers for any of a variety of known display devices for presenting information to a user, whether a human or a machine, whether local or remote. In the illustrated embodiment, the functional elements of computer 150 communicate with each other via system bus 153. Some of these communications may be accomplished in alternative embodiments using network or other types of remote communications.

As will be evident to those skilled in the relevant art, applications/executables 172A, if implemented in software, may be loaded into system memory 170 and/or memory storage device 181. All or portions of applications/executables 172A may also reside in a read-only memory or similar device of memory storage device 181, such devices not requiring that applications/executables 172A first be loaded through input-output controllers 175. It will be understood by those skilled in the relevant art that applications/executables 172A, or portions of it, may be loaded by processor 155 in a known manner into system memory 170, or cache memory (not shown), or both, as advantageous for execution.

Network 125 may be one among the many various types of networks well known to those of ordinary skill in the art. In one possible embodiment, network 125 may include what is commonly referred to as a TCP/IP network.

Instrument control and image processing applications 172: Instrument control and image processing applications 172 may be any of a variety of known or future image processing applications. Examples of applications 172 include Affymetrix® Microarray Suite, Affymetrix® GeneChip® Operating Software (hereafter referred to as GCOS), and Affymetrix® Jaguar™ software, noted above. Applications 172 may be loaded into system memory 170 and/or memory storage device 181 through one of input devices 140. Applications 172 as loaded into system memory 170 are shown in FIG. 1 as instrument control and image processing applications executables 172A.

Embodiments of applications 172 includes executables 172A being stored in system memory 170 of an implementation of computer 150 that includes what is commonly referred to by those of ordinary skill in the related art as a client workstation. Executables 172A may provide a single interface for both the client workstation and one or more servers such as, for instance, GeneChip® Operating Software Server (GCOS Server). Executables 172A could additionally provide the single user interface for one or more other workstations and/or one or more instruments. In the presently described implementation, the single interface may communicate with and control one or more elements of the one or more servers, one or more workstations, and the one or more instruments. In the described implementation the client workstation could be located locally or remotely to the one or more servers and/or one or more other workstations, and/or one or more instruments. The single interface may, in the present implementation, include an interactive graphical user interface that allows a user to make selections based upon information presented in the GUI.

In alternative implementations, applications 172 may be executed on a server, or on one or more other computer platforms connected directly or indirectly (e.g., via another network, including the Internet or an Intranet) to network 125.

Embodiments of applications 172 also include instrument control features. The instrument control features may include the control of one or more elements of one or more instruments that could, for instance, include elements of a fluidics station, what may be referred to as an autoloader, and scanner 110. The instrument control features may also be capable of receiving information from the one more instruments that could include experiment or instrument status, process steps, or other relevant information. The instrument control features could, for example, be under the control of or an element of the single interface. In the present example, a user may input desired control commands and/or receive the instrument control information via a GUI.

In some embodiments, image data is operated upon by executables 172A to generate intermediate results. Examples of intermediate results include so-called cell intensity files (*.cel) and chip files (*.chp) generated by Affymetrix® GeneChip® Operating Software or Affymetrix® Microarray Suite (as described, for example, in U.S. patent application Ser. No. 10/219,882, and Attorney Docket Number 3348.9, titled “System, Method and Computer Software Product for Instrument Control, Data Acquisition, Analysis, Management and Storage”, filed Jan. 26, 2004, both of which are hereby incorporated herein by reference in their entireties for all purposes) and spot files (*.spt) generated by Affymetrix® Jaguar™ software (as described, for example, in PCT Application PCT/US 01/26390 and in U.S. patent application Ser. Nos. 09/681,819, 09/682,071, 09/682,074, and 09/682,076, all of which are hereby incorporated by reference herein in their entireties for all purposes). For convenience, the term “file” often is used herein to refer to data generated or used by executables 172A and executable counterparts of other applications, but any of a variety of alternative techniques known in the relevant art for storing, conveying, and/or manipulating data may be employed.

For example, executables 172A receives image data derived from a GeneChip® probe array and generates a cell intensity file. This file contains, for each probe scanned by scanner 110, a single value representative of the intensities of pixels measured by scanner 110 for that probe. Thus, this value is a measure of the abundance of tagged mRNA's present in the target that hybridized to the corresponding probe. Many such mRNA's may be present in each probe, as a probe on a GeneChip® probe array may include, for example, millions of oligonucleotides designed to detect the mRNA's. As noted, another file illustratively assumed to be generated by executables 172A is a chip file. In the present example, in which executables 172A include Affymetrix® GeneChip® Operating Software, the chip file is derived from analysis of the cell file combined in some cases with information derived from lab data and/or library files that specify details regarding the sequences and locations of probes and controls. The resulting data stored in the chip file includes degrees of hybridization, absolute and/or differential (over two or more experiments) expression, genotype comparisons, detection of polymorphisms and mutations, and other analytical results.

In another example, in which executables 172A includes Affymetrix® Jaguar™ software operating on image data from a spotted probe array, the resulting spot file includes the intensities of labeled targets that hybridized to probes in the array. Further details regarding cell files, chip files, and spot files are provided in U.S. patent application Ser. Nos. 09/682,098, 09/682,071, and 10/126,468, incorporated by reference above. As will be appreciated by those skilled in the relevant art, the preceding and following descriptions of files generated by executables 172A are exemplary only, and the data described, and other data, may be processed, combined, arranged, and/or presented in many other ways.

User 105 and/or automated data input devices or programs (not shown) may provide data related to the design or conduct of experiments. As one further non-limiting example related to the processing of an Affymetrix® GeneChip® probe array, the user may specify an Affymetrix catalogue or custom chip type (e.g., Human Genome U95Av2 chip) either by selecting from a predetermined list presented by GCOS or by scanning a bar code related to a chip to read its type. GCOS may associate the chip type with various scanning parameters stored in data tables including the area of the chip that is to be scanned, the location of chrome borders on the chip used for auto-focusing, the wavelength or intensity of laser light to be used in reading the chip, and so on. As noted, executables 172A may apply some of this data in the generation of intermediate results. For example, information about the dyes may be incorporated into determinations of relative expression.

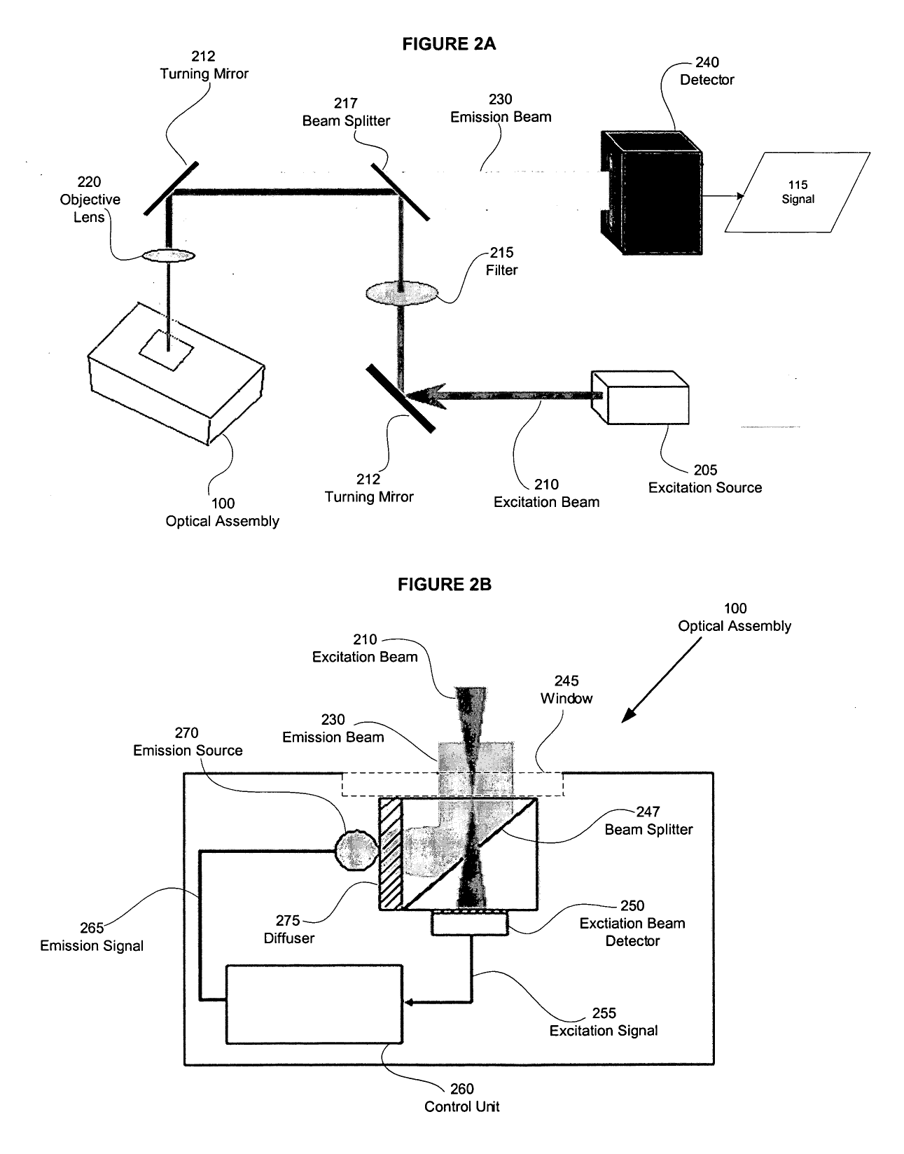

Scanner Optics and Detectors: FIG. 2A illustrates a simplified graphical example of components associated with the scanner optics and detectors that may correspond to components embodied in scanner 110. The exemplary components include excitation source 205 that may, for instance be a laser; wide spectrum type bulb, x-ray sources, one or more light emitting diodes or other type of source known to those of ordinary skill in the related art. For example, an implementation of a laser as source 205 could include what may be referred to as a Nd: YAG or YVO4 laser producing green laser light having a wavelength of 532 nm (nanometers).

In some embodiments such as that illustrated in FIG. 2A, only one laser and accordingly, only one illumination or excitation beam may be used during each scan. Those of ordinary skill in the related art will appreciate that other embodiments exist such as for example, an embodiment that encompasses a plurality of lasers or other implementations of source 205 that may provide specific utility in scanner 110. Examples of utility could include, a implementation of source 205 that emits in a wavelength that is substantially near what is referred to as the infra-red wavelength that may be used specifically for calibration purposes, or two or more implementations of source 205 each specific for exciting a particular range of fluorescent molecule that may enable scanner 110 to excite and detect a wide range of fluorescence.

As illustrated in FIG. 2A, excitation beam 210 is directed along the optical path by a number of turning mirrors 212. Mirrors 212 may be employed in scanner 110 to provide for adjustability of the path of beam 210 thus enabling alignment of beam 210 at the objective lens and on towards optical assembly 100. In some embodiments, turning mirrors 212 may serve to “fold” the optical path into a more compact size and shape to facilitate overall scanner packaging.

Filter 215 may be employed in some implementations to remove light at wavelengths other than the desired wavelengths, and need not be included if, for example, source 205 does not produce light at these extraneous wavelengths. However, it may be desirable in some applications to use inexpensive lasers or other implementations of source 205 and often it is cheaper to filter out-of-mode light than to design source 205 to avoid producing such extraneous emissions.

As illustrated in FIG. 2A, excitation beam 210 proceeds to beam splitter 217 that may include a Dichroic Mirror, Geometric beam Splitter, or other type of means of optically separating particular wavelengths of light or other characteristics of light known to those of ordinary skill in the related art. For example, beam splitter 217 may be highly reflective to a range of wavelengths of light such as for instance the wavelength associated with excitation beam 210, and highly transmissive to a second range of wavelengths such as, for instance, the wavelength associated with emission beam 230. Continuing the example of FIG. 2A, beam splitter 217 reflects most of excitation beam 210.

In some embodiments, objective lens 220 may be a small, light-weight lens that could for instance include what is referred to as a high numerical aperture lens. The term “numerical aperture” generally refers to the ability of lens 220 to collect light at various distances where a high numerical aperture lens generally refers to a lens capable of a high collection efficiency at a close range. Also, lens 220 may produce what is referred to as a convergent/divergent beam that focuses the beam to a point that may also correspond to the best plane of focus or “object plane”.

In the same or alternative embodiments, emission beam 230 generally corresponds to a range of wavelengths produced by fluorescent molecules in response to an excitation wavelength. For example, a fluorescent molecule or “fluorophore” may be excited by light within a certain range of wavelengths, including light having a 532 nm (nanometer) wavelength, and then emit a light within a certain range of wavelength, including a wavelength of 570 nm. In the present example, the intensity of the emitted beam may depend on the intensity or “power” of the excitation beam.

Emission beam 230, in the example illustrated in FIG. 2A, follows the reverse path as described above with respect to excitation beam 210 until reaching beam splitter 217 that may be transmissive to the wavelength of beam 230.

Detector 240 may include any of a variety of conventional devices for detecting emission beam 230, such as a silicon detector for providing an electrical signal representative of detected light, a photodiode, a charge-coupled device, a photomultiplier tube, or any other detection device for providing a signal indicative of detected light that is now available or that may be developed in the future. Detector 240 generates signal 115 that represents detected emission beam 230. In accordance with known techniques, the amplitude, phase, or other characteristic of signal 115 is may depend on the wavelength, and power of emission beam 102 as well as one or more parameters of detector 240 such as, for instance, an adjustable gain setting. For example, one or more of the characteristics of signal 115, as described above, may tunable or calibrated to a particular standard by adjusting what may be referred to as the “detector gain” or simply as “gain” that may be associated with the “sensitivity” of detector 240 to light of varying power levels at particular wavelengths. As those of ordinary skill in the relevant art will appreciate, the term “gain” generally refers to the ratio of output power to input power. In the present example, the input power may be generally interpreted to mean the power of emission beam 230 impinging on detector 240 and output power may be generally interpreted to mean the power of signal 115 generated by detector 240. The term “power” as used herein with respect to excitation beam 210, emission beam 230, and signal 115, generally refers to a measure of energy that, for instance, include Milliwatts, Watts, Joules, Kilojoules, or other measures commonly used in the related art.

In one embodiment, detector 240 may emit signal 115 in response to emission beam 230. For example, the characteristics of signal 115 may be based, at least in part, upon one or more characteristics of emission beam 230 such as, for instance, the power and wavelength of beam 230, and one or more characteristics of detector 240 such as, for instance, a gain setting associated with detector 240. In the present example, signal 115 is received by computer 150 for processing by executables 172A that may include an association of signal 115 with one or more standard values, where executables 172A may perform one or more operations such as gain calibration so that signal 115 is substantially the same as one of the one or more standard values.

Optical Assembly 100:

It may be desirable to calibrate one or more scanners to one or more specified standards to provide consistent data quality that may be matched from instrument to instrument where the data from a first instrument is comparable to data from a second instrument. In some implementations, periodic calibration of each of the one or more instruments may be desirable to compensate for variations in components that could affect the proper acquisition and analysis of image data. Such variations could include those caused by mechanical or optical elements that are affected by a variety of factors including temperature fluctuation, mechanical wear, component imperfections, slight changes caused by physical insult, or other of a variety of possible factors. In one implementation scanner 110 could be initially calibrated at the factory then during routine service in the field. Alternatively or in addition to the previous implementation, the calibration operation could be automatically performed prior to or during each scan, during the power-up routine of the scanner, or at other frequent intervals. One or more components of scanner 110 may include one or more adjustable parameters for calibration such as, for instance, adjustment of power of light emitted from source 205 or adjustment of gain of detector 240.

Embodiments of the present invention include a stable calibration standard that may be employed to provide each of scanners 110 a reference for calibration. For example, those of ordinary skill in the related art will appreciate that calibration standards for fluorescent detection instruments are inadequate for a variety of reasons such as, for example the lack of a fluorescent molecule to be used as a standard that exhibits the same excitation and emission characteristics of fluorescent molecules associated with experiments with biological probe arrays as well as a high degree of photo stability necessary for use as a fluorescent standard. In the present example, light emitted form a stable non-fluorescent source may include one or more characteristics and/or be conditioned to be substantially the same as fluorescent light emitted in response to one or more characteristics of excitation light.

Illustrated in FIG. 2B is a simplified graphical representation of optical assembly 100 that may, for instance, include a compact shape and design that is substantially the same size and shape of a probe array cartridge or housing, such as a GeneChip® cartridge, that scanner 110 may readily accept. Also, some embodiments of optical assembly 100 may require an external or internal power source for one or more components. For example, assembly 100 may include a wire that transmits power from an external source to each of the one or more components that require it, or alternatively to a single component, such as control unit 260 that then distributes power as necessary. Alternatively, assembly 100 may include an internal battery that provides power to the one or more components. In some embodiments, assembly 100 may use the power received in excitation beam 210 to perform the operations required of the components.

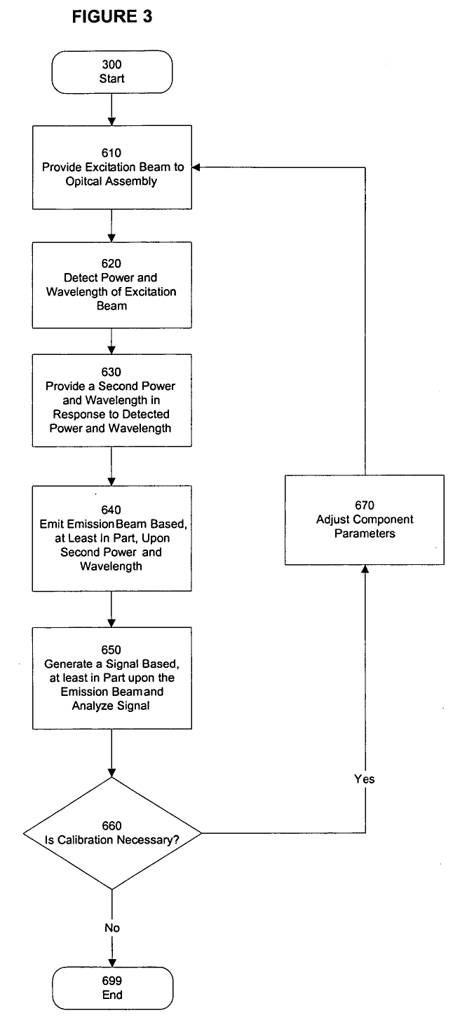

As illustrated in FIG. 2B and an exemplary method of use illustrated in FIG. 3, optical assembly 100 may include Beam splitter 247 that may be a similar implementation of a dichroic mirror or other means of optical separation as previously described as beam splitter 217 where the embodiment of beam splitter 247 may differ from that of splitter 217 where splitter 247 is transmissive to excitation beam 210 and reflective to emission beam 230. However, those of ordinary skill will appreciate that alternative embodiments of splitter 247 may function similar to splitter 217 and that is transmissive to emission beam 230 and reflective to excitation beam 210. For example, in such embodiments the relative positions as illustrated in FIG. 2B of detector 250 and source 270 may be exchanged.

As illustrated in step 610 scanner 110 provides excitation beam 210 to optical assembly 100 that has been positioned within scanner 110 so that window 245 is at the “object plane” defined by the numerical aperture of objective lens 220. In the present example, beam 210 includes a particular wavelength and power that may be defined by the settings of one or more parameters of scanner 110. Excitation beam 210 passes through window 245 to beam splitter 247 that is substantially transmissive to beam 210, allowing excitation beam 210 to impinge upon excitation beam detector 250.

Some embodiments of excitation beam detector 250, like detector 190, may include silicon detector for providing an electrical signal representative of detected light, photodiode, charge-coupled device, photomultiplier tube, or any other detection device that is now available or that may be developed in the future. For example, detector 250 may emit one or more excitation signals 255 in response to excitation beam 210 where signal 255 may be based upon one or more characteristics of beam 210 such as power, wavelength, frequency, or amplitude.

As illustrated in step 620, excitation beam detector 250 detects the level of power of beam 210 and/or wavelength and provides excitation signal 255 based, at least in part, upon the detected power and/or wavelength.

Control unit 260 may, as illustrated in step 630, provide emission signal 265 based, at least in part, upon one or more of the characteristics of excitation signal 255. For example, control unit 260 may determine the wavelength and/or power associated with excitation beam 210 from one or more characteristics of excitation signal 255. Control unit 260 may then associate the one or more characteristics of signal 255 with a second set of one or more characteristics associated with known characteristics of fluorescent molecules known to those of ordinary skill in the related art. In the present example, the fluorescent molecules include molecules that may be associated with target molecules such as, for instance, Phycoerythrin, Cy3, Cy5, Alexa, Fluorescein, or other fluorescent molecules commonly used in experiments with biological probe arrays. Also in the present example, emission signal 265 emitted by control unit 260 is an imitation of what an expected fluorescent emission by a particular fluorescent molecule in response to the one or more characteristics of excitation beam 210 such as, for instance, the power of beam 210. Some embodiments of control unit 260 may be “hard coded” to mimic a particular fluorescent molecules emission, or alternatively control unit 260 may be enabled to dynamically produce a mimicked emission based, at least in part, upon the wavelength of beam 210, or via a signal provided by executables 172A where assembly 100 may include some means of connectivity for data transmission such as a wire, radio, infra-red, ultrasonic, or other means known in the art. Additionally, in the same or other example, control unit 260 may emit emission signal 265 for the entire period that excitation beam 210 is detected by detector 250 as well as dynamically change one or more characteristics of emission signal 265 in response to detected changes of one or more characteristics of excitation beam 210 such as, for instance, executables 172A may adjust the power of excitation beam 210 to test different detector responses.

As illustrated in step 640, emission source 270 may emit emission beam 230 based, at least in part, upon emission signal 265. Similar to source 205, emission source 270 may include light emitting diodes, incandescent light source, solid state laser or any other light compact light source known to those of ordinary skill. For example, emission source 270 includes one or more light emitting diodes enabled to provide light emissions, including mimicked fluorescent emissions in a wide spectrum of wavelengths and power levels.

In some embodiments, diffuser 275 may include a filter that may be similar to filter 140 and used to remove light at wavelengths other than the desired wavelengths, and need not be included if, for example, source 270 does not produce light at these extraneous wavelengths. In the same or alternative embodiments, diffuser 275 may be enabled to provide “diffuse” light from a point light source where the diffuse light is substantially the same as emitted light from a fluorescent molecule. For example, emitted light from source 270 may include light that is not characteristic of light emitted from a fluorescent molecule such as, for instance the brightness, or collimated nature of some light where diffuser “conditions” the light emitted from source 270 so that emission beam 230 is substantially the same as light emitted from a fluorescent molecule.

As illustrated in step 650, emission beam 230 is received by detector 240 of scanner 110 and produces signal 115, where executables 172A analyzes one or more characteristics of signal 115 where the analysis may include comparing one or more of the characteristics to a standard value. In the present example illustrated in decision element 660, if the one or more characteristics are substantially the same as the standard value then no further calibration may be necessary. Alternatively as illustrated in step 670, executables 172A may adjust one or more parameters of one or more components of scanner 110 based, at least in part, upon a degree of difference between the one or more characteristics and the standard value. In the present example, the method may be repeated serially such as, for instance, measuring and calibrating in alternating processes, or dynamically such as, for instance, simultaneously measuring and calibrating, to insure proper calibration.

Having described various embodiments and implementations, it should be apparent to those skilled in the relevant art that the foregoing is illustrative only and not limiting, having been presented by way of example only. Many other schemes for distributing functions among the various functional elements of the illustrated embodiment are possible. The functions of any element may be carried out in various ways in alternative embodiments.

Also, the functions of several elements may, in alternative embodiments, be carried out by fewer, or a single, element. Similarly, in some embodiments, any functional element may perform fewer, or different, operations than those described with respect to the illustrated embodiment. Also, functional elements shown as distinct for purposes of illustration may be incorporated within other functional elements in a particular implementation. Also, the sequencing of functions or portions of functions generally may be altered. Certain functional elements, files, data structures, and so on may be described in the illustrated embodiments as located in system memory of a particular computer. In other embodiments, however, they may be located on, or distributed across, computer systems or other platforms that are co-located and/or remote from each other. In addition, it will be understood by those skilled in the relevant art that control and data flows between and among functional elements and various data structures may vary in many ways from the control and data flows described above or in documents incorporated by reference herein. More particularly, intermediary functional elements may direct control or data flows, and the functions of various elements may be combined, divided, or otherwise rearranged to allow parallel processing or for other reasons. Also, intermediate data structures or files may be used and various described data structures or files may be combined or otherwise arranged. Numerous other embodiments, and modifications thereof, are contemplated as falling within the scope of the present invention as defined by appended claims and equivalents thereto.

What is claimed is:

1. A system for providing a wavelength of light, comprising:
a scanner that provides a first wavelength; and
an optical assembly that emits a second wavelength based, at least in part upon the first wavelength, wherein the second wavelength is not the result of a fluorescent emission.

2. The system of claim 1, wherein:
the first wavelength corresponds to a wavelength that excites one or more fluorescent molecules.

3. The system of claim 1, wherein:
the fluorescent emission corresponds to an emission from a fluorescent molecule associated with a target molecule.

4. The system of claim 3, wherein:
the target molecule is present in a biological sample.

5. The system of claim 1, wherein:
the optical assembly further comprises:
a detector that detects a first measure of power associated with the first wavelength;
a control unit that provides a second measure of power proportional to the first measure of power, wherein the second measure of power is associated with the second wavelength; and
a source that emits the second wavelength at the second measure of power.

6. The system of claim 1, further comprising:
an instrument control application that calibrates one or more detectors associated with the scanner.

7. The system of claim 6, wherein:
the calibration includes a gain calibration.

8. A method for providing a wavelength of light comprising:
providing a first wavelength; and
emitting a second wavelength based, at least in part upon the first wavelength, wherein the second wavelength is not the result of a fluorescent emission.

9. The method of claim 8, wherein:
the first wavelength corresponds to a wavelength capable of exciting one or more fluorescent molecules.

10. The method of claim 8, wherein:
the fluorescent emission corresponds to an emission from a fluorescent molecule associated with a target molecule.

11. The method of claim 10, wherein:
the target molecule is present in a biological sample.

12. The method of claim 8, wherein the step of emitting further comprises:
detecting a first measure of power associated with the first wavelength;
providing a second measure of power proportional to the first measure of power, wherein the second measure of power is associated with the second wavelength; and
emitting the second wavelength at the second measure of power.

13. The method of claim 8, further comprising:
calibrating one or more detectors associated with a scanner based, at least in part, upon the second wavelength and the second measure of power.

14. An optical assembly, comprising:
a detector that detects a first measure of power associated with a first wavelength;
a control unit that provides a second measure of power proportional to the first measure of power, wherein the second measure of power is associated with a second wavelength; and
a source that emits the second wavelength at the second measure of power.

15. The optical assembly of claim 14, wherein:
the first wavelength corresponds to a wavelength that excites one or more fluorescent molecules.

16. The optical assembly of claim 14, wherein:
the second wavelength is not the result of a fluorescent emission.

17. The optical assembly of claim 16, wherein:
the fluorescent emission corresponds to an emission from a fluorescent molecule associated with a target molecule.

18. The optical assembly of claim 17, wherein:
the target molecule is present in a biological sample.

19. A method of using an optical assembly, comprising:
detecting a first measure of power associated with a first wavelength;
providing a second measure of power proportional to the first measure of power, wherein the second measure of power is associated with a second wavelength; and
emitting the second wavelength at the second measure of power.

20. A system for calibrating a scanner, comprising:
a scanner that provides a first wavelength;
a first detector that detects a first measure of power associated with the first wavelength;
a control unit that provides a second measure of power proportional to the first measure of power, wherein the second measure of power is associated with a second wavelength;
a source that emits the second wavelength at the second measure of power;
a second detector associated with the scanner, wherein the second detector generates a signal based, at least in part, upon the second wavelength and the second measure of power; and
an instrument control application that calibrates the second detector based, at least in part, upon the signal.

21. The system of claim 20, wherein:
the second wavelength is not the result of a fluorescent emission.

22. The system of claim 21, wherein:
the fluorescent emission corresponds to an emission from a fluorescent molecule associated with a target molecule.

23. The system of claim 20, wherein:
the first wavelength corresponds to a wavelength that excites one or more fluorescent molecules.

24. The system of claim 20, wherein:
the calibration includes a gain calibration.

25. A method for calibrating a scanner, comprising:
providing a first wavelength;
detecting a first measure of power associated with the first wavelength;
providing a second measure of power proportional to the first measure of power, wherein the second measure of power is associated with a second wavelength;
emitting the second wavelength at the second measure of power;
generating a signal based, at least in part, upon the second wavelength and the second measure of power; and
calibrating the second detector based, at least in part, upon the signal.

26. A system for calibrating a scanner, comprising:
a scanner that provides a first wavelength;
an optical assembly that comprises:
a first detector that detects a first measure of power associated with the first wavelength;
a control unit that provides a second measure of power proportional to the first measure of power, wherein the second measure of power is associated with a second wavelength; and
a source that emits the second wavelength at the second measure of power;
a second detector associated with the scanner, wherein the second detector generates a signal based, at least in part, upon the second wavelength and the second measure of power; and
a computer having system memory with an instrument control application stored thereon, wherein the instrument control application executes the step of:
calibrating the second detector based, at least in part, upon the signal.
